(19) United States
(12) Patent Application Publication
(10) Pub. No.: US 2024/0421364 A1
(43) Pub. Date: Dec. 19, 2024

(54) BATTERY MONITORING SYSTEM

(71) Applicant: LAPIS Technology Co., Ltd., Yokohama-shi (JP)

(72) Inventor: Masato YAMAZAKI, Yokohama-shi (JP)

(21) Appl. No.: 18/820,467

(22) Filed: Aug. 30, 2024

Related U.S. Application Data
(63) Continuation of application No. PCT/JP2023/008175, filed on Mar. 3, 2023.

(30) Foreign Application Priority Data
Mar. 4, 2022 (JP) 2022-033892

(51) Int. Cl. H01M 10/42

(52) U.S. Cl. CPC H01M 10/425; H01M 10/4207; H01M 2010/4271; H01M 2010/4278

(57) ABSTRACT

In a battery monitoring system, when a communication interface circuit receives an output command for monitoring data of each cell according to an instruction from a battery management circuit, the output commands are simultaneously transmitted from a third connection port and a fourth connection port of the communication interface circuit to both of a first connection port of a group and a second connection port of the group in a battery pack unit group, communication control is performed such that the output commands are transmitted to all of plural battery pack units, and communication data output from each of the plural battery pack units is output from both of the connection ports.

### TECHNICAL FIELD

The present disclosure relates to a battery monitoring system.

### BACKGROUND ART

Hitherto, there is a technology related to cell state monitoring using a communication method of daisy chain connection in which units of a plurality of cells are connected in series.

For example, there is a technology related to a daisy chain communication bus and a protocol (see Japanese Patent Application Laid-Open No. 2015-076890). In this technology, a communication circuit delivers cell state data to a circuit on a first side via a first connection node in one direction of a bidirectional data path. Further, in response to an indication that the bidirectional data path is incomplete, the cell state data is delivered to a circuit on a second side via a second connection node in the other direction of the bidirectional data path.

### Technical Problem

The related art discloses an example of a battery management system in which a plurality of communication circuits mounted on battery cells are daisy-chained so as to be bidirectionally communicable and managed by a battery manager. The battery manager performs communication in one direction in a normal state, and in a case where an abnormality such as disconnection occurs between any of the cells, the battery manager performs communication in the opposite direction, thereby enabling management of the battery cells even when an abnormality occurs.

As described above, in a case where communication of a path on one side is disabled at the time of occurrence of an abnormality, a route change for performing communication in another direction is made. However, since it is necessary to switch the route after detecting a portion of the path in which communication is disabled, communication can be delayed when an abnormality occurs.

An object of the disclosed technology is to provide a battery monitoring system that enables continuous operation without causing a stop due to detection even in a case where an abnormality occurs between connection ports.

### Solution to Problem

### SUMMARY

A battery monitoring system according to the present disclosure includes: a battery pack unit including a cell monitoring circuit that monitors a plurality of cells, a communication circuit for transmitting obtained monitoring data to an exterior, and first and second connection ports for transmitting communication data including the monitoring data; a battery pack unit group in which a plurality of the battery pack units are connected in series; a battery management circuit configured to control the battery pack unit in response to the monitoring data of each cell in the battery pack unit; and a communication interface circuit arranged so as to transmit the monitoring data between the battery pack unit group and the battery management circuit, in which in connection between the battery pack units of the battery pack unit group, a first connection port of the battery pack unit is connected to the second connection port of an adjacent battery pack unit, a second connection port of the battery pack unit is connected to the first connection port of another adjacent battery pack unit to form the battery pack unit group in which the battery pack units are onnected in series by a daisy-chain connection, the battery pack unit group includes a first connection port of the group and a second connection port of the group, the first connection port of the group is connected to a fourth connection port of the communication interface circuit, the second connection port of the group is configured to be connected to a third connection port of the communication interface circuit, and when the communication interface circuit receives an output command for the monitoring data of each cell according to an instruction from the battery management circuit, the output commands are simultaneously transmitted from the third connection port and the fourth connection port of the communication interface circuit to both of the first connection port of the group and the second connection port of the group in the battery pack unit group, communication control is performed such that the output commands are transmitted to all of the plurality of battery pack units, and the communication data output from each of the plurality of battery pack units is output from both of the connection ports.

### BRIEF DESCRIPTION OF DRAWINGS

FIG. 1 is a diagram showing a configuration of a battery monitoring system.

FIG. 2 is a diagram showing a configuration of bus arbitration between connection ports.

FIG. 3 is a diagram showing bus arbitration for each transmission method.

FIG. 4 is a diagram showing an example of time transition of communication in a case where a communication interface circuit simultaneously transmits requests, and output commands are received from both directions by certain battery pack units.

FIG. 5 is a diagram showing an example of abnormality detection and abnormal portion detection using a communication path dialog command.

FIG. 6A is a timing chart in a case where a transmission request is transmitted only to a first connection port 21A.

FIG. 6B is a timing chart in a case where the transmission request is transmitted only to the first connection port 21A.

FIG. 7A is a timing chart in a case where the transmission request is transmitted only to a second connection port 21B.

FIG. 7B is a timing chart in a case where the transmission request is transmitted only to the second connection port 21B.

FIG. 8A is a timing chart in a case where the transmission requests are simultaneously transmitted to the first connection port 21A and the second connection port 21B.

FIG. 8B is a timing chart in a case where the transmission requests are simultaneously transmitted to the first connection port 21A and the second connection port 21B.

FIG. 8C is a timing chart in a case where the transmission requests are simultaneously transmitted to the first connection port 21A and the second connection port 21B.

FIG. 9 shows a case where a slave first makes a Req request, and a bus ownership is with the slave, and data is transferred from the slave to a master.

FIG. 10 shows a case where both the master and the slave simultaneously make the Req requests, the bus ownership is with the master, and data is transferred from the master to the slave.

FIG. 11 shows a case where the master first makes the Req request, the bus ownership is with the master, and data is transferred from the master to the slave.

### DESCRIPTION OF EMBODIMENTS

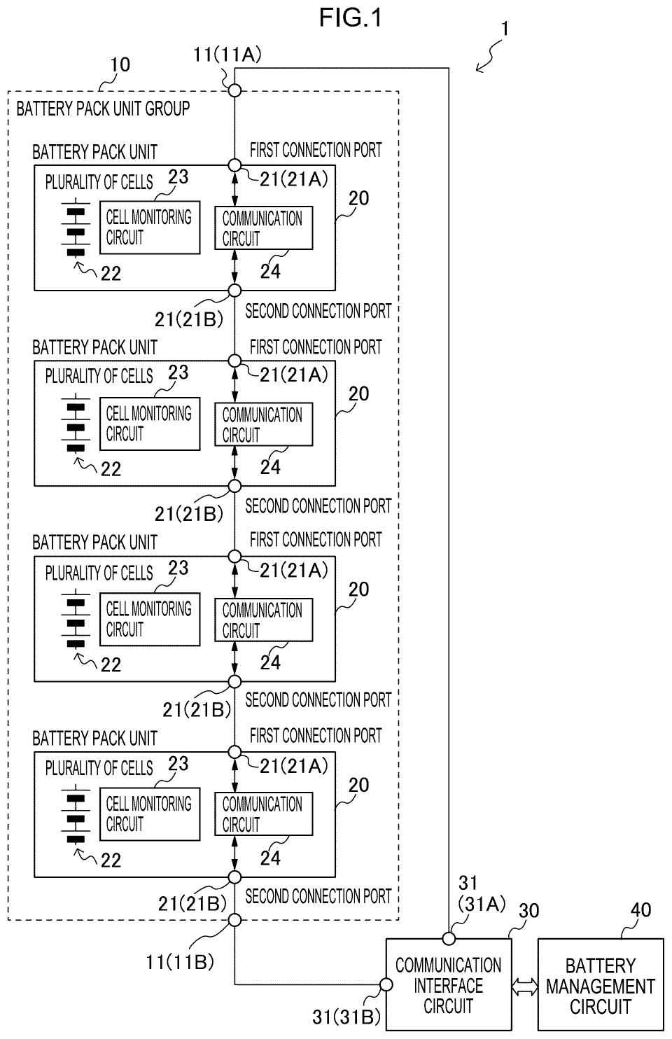

Hereinafter, an embodiment of the present disclosure (hereinafter, referred to as the present embodiment) will be described with reference to the drawings. FIG. 1 is a diagram showing a configuration of a battery monitoring system. A battery monitoring system 1 includes a battery pack unit group 10 including a plurality of battery pack units 20, a communication interface circuit 30, and a battery management circuit 40. The plurality of battery pack units 20 of the battery pack unit group 10 are daisy-chained in series by connection ports. The communication interface circuit 30 is arranged so as to transmit monitoring data between the battery pack unit group 10 and the battery management circuit 40.

The battery management circuit 40 is configured to control the battery pack unit 20 in response to the monitoring data of each cell in the battery pack unit 20.

The battery pack unit 20 includes a cell monitoring circuit 23 that monitor a plurality of cells 22, a communication circuit 24 for transmitting obtained monitoring data to the outside, and connection ports 21 for transmitting communication data including the monitoring data. The connection ports include a first connection port 21A on a master side and a second connection port 21B on a slave side in daisy chain connection. When describing matters common for the first connection port 21A and the second connection port 21B, the first connection port 21A and the second connection port 21B may be simply referred to as the connection ports. The battery pack unit 20 and a battery pack unit 20 adjacent to the battery pack unit 20 (the battery pack units) perform communication with each other via a bus including the first connection port 21A, the second connection port 21B, and the communication circuit 24. The battery pack unit 20 is an example of a communication device (first or second communication device) of the present disclosure, and the communication circuit 24 is an example of a communication unit.

In the battery pack unit group 10, a first connection port 11A of the group is connected to a third connection port 31A of the communication interface circuit 30, and a second connection port 11B of the group is connected to a fourth connection port 31B of the communication interface circuit 30. The first connection port 11A of the group may be the first connection port 21A of the battery pack unit 20 at an end portion of the connection. The second connection port 11B of the group may be the second connection port 21B of the battery pack unit 20 at an end portion of the connection.

### [Configuration Between Connection Ports]

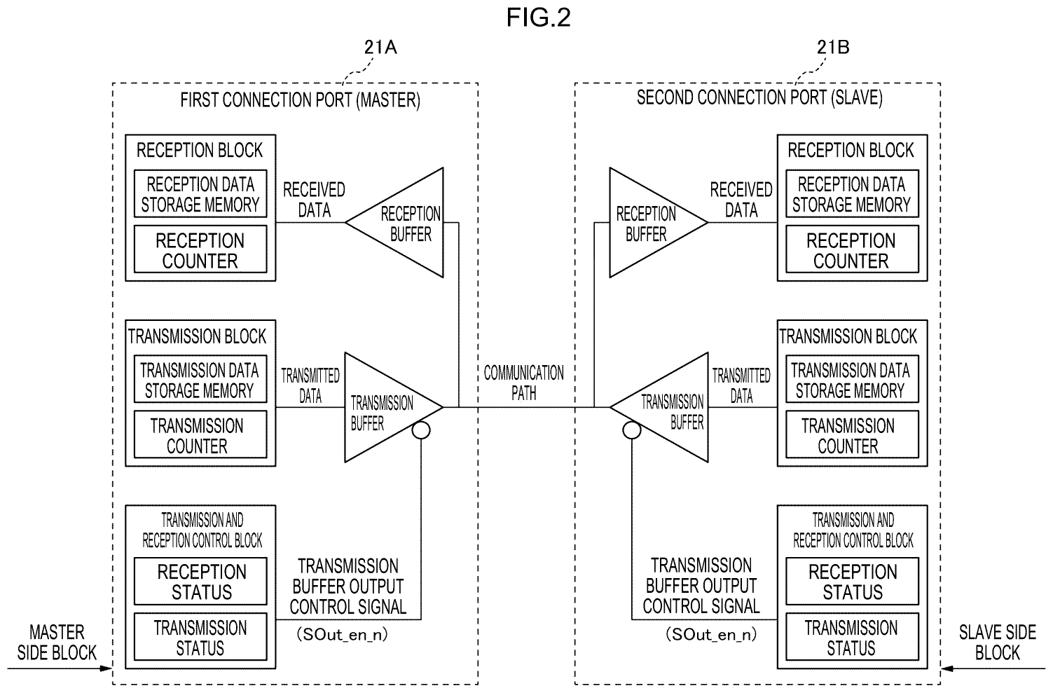

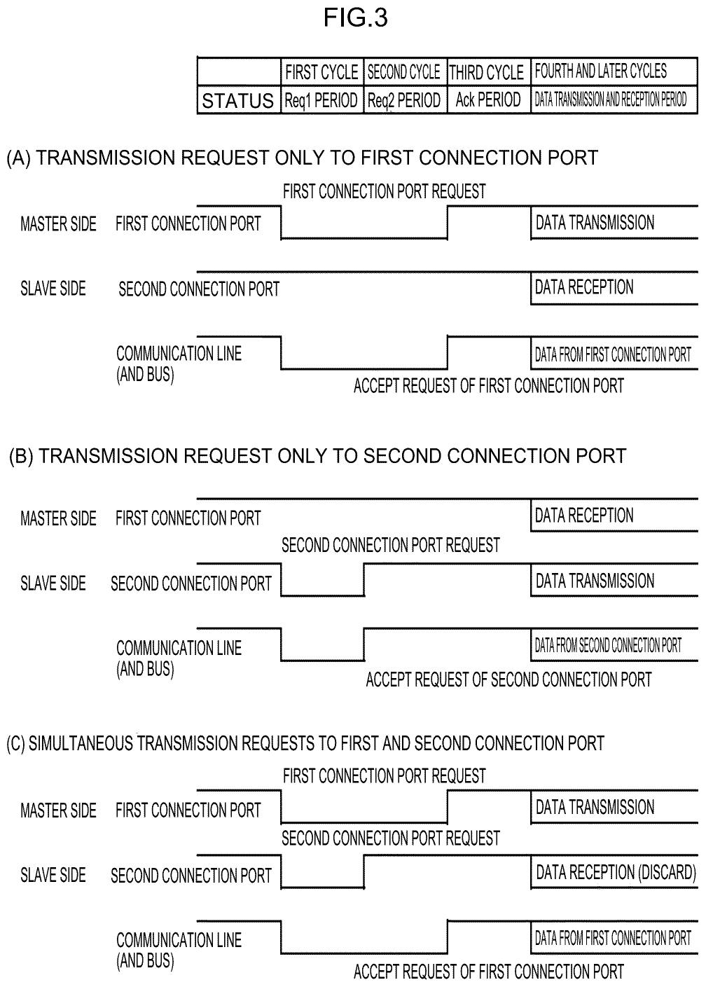

Next, the case of bus arbitration between the first connection port 21A and the second connection port 21B will be described. Hereinafter, a case where the bus arbitration is configured by an AND bus will be described as an example. FIG. 2 is a diagram showing the configuration of the bus arbitration between the connection ports. FIG. 3 is a diagram showing bus arbitration for each transmission method.

A communication path (including the communication circuit 24) in FIG. 2 is the AND bus. As shown in FIG. 2, received data is received by a reception buffer, and transmitted data is transmitted by a transmission buffer for data communication between the connection ports. A reception block stores the received data in a received data storage memory, and counts/clears a reception counter value by a reception counter. A transmission block transmits the transmitted data stored in a transmitted data storage memory, and counts/clears a transmission counter value by a transmission counter. A reception control block manages a reception status and a transmission status. A transmission buffer output control signal (SOut_en_n) becomes Active when the transmission status (SStatus) is Reg1, Req2, or Send.

### [Bus Arbitration of Embodiment]

In a case where the AND bus is used between the first connection port 21A and the second connection port 21B, a high state is established at the time of non-communication, and a bus ownership of the AND bus is in a free state. When the bus ownership of the AND bus is in the free state for both the first connection port 21A and the second connection port 21B, the communication circuit 24 outputs a request signal to request for the bus ownership.

(A) of FIG. 3 shows a case where a transmission request signal (hereinafter, simply referred to as a transmission request) is transmitted only to the first connection port 21A, (B) of FIG. 3 shows a case where the transmission request is transmitted only to the second connection port 21B, and (C) of FIG. 3 shows a case where the transmission requests are simultaneously transmitted to both the first connection port 21A and the second connection port 21B and the request of the first connection port 21A is accepted. In the battery monitoring system 1 of the embodiment, the bus arbitration of (C) is adopted.

In a case where the communication circuit 24 desires to start communication by using the first connection port 21A, the communication circuit 24 requests for the bus ownership by driving two data cycles (first and second cycles) to be low. If the second cycle is monitored and is low, the transmitted data is transmitted from the next cycle (third cycle) by securing the bus ownership of the AND bus.

In a case where the communication circuit 24 desires to start communication by using the second connection port 21B, the communication circuit 24 requests for the bus ownership by driving one data cycle (first cycle) to be low. If the second cycle is monitored and is high, the transmitted data is transmitted from the next cycle (third cycle) by securing the bus ownership of the AND bus.

When both the first connection port 21A and the second connection port 21B output the transmitted data and the communication is completed, the communication circuit 24 releases the bus ownership of the AND bus and transitions to the high state at the time of non-communication.

In (A), the transmission request is transmitted from the communication circuit 24 only to the first connection port 21A, the request of the first connection port 21A is accepted by driving two cycles to be low, and a communication line (AND bus) receives the data of the first connection port 21A. In (B), the transmission request is transmitted from the communication circuit 24 only to the second connection port 21B, the request of the second connection port 21B is received by driving one cycle to be low, and the communication line (AND bus) receives the data of the second connection port 21B.

In (C), in a case where the transmission requests are simultaneously transmitted from different communication circuits 24 to the first connection port 21A and the second connection port 21B, communication of the connection ports requested from one communication circuit 24 is applied, and data reception requested from the other communication circuit 24 is discarded. In the example of (C), since the first connection port 21A accepts the request as the master side, the data reception of the second connection port 21B (slave side) is discarded, and the communication line (AND bus) accepts the data of the first connection port 21A. As described above, in a bus control method, the communication circuit 24 in the bus monitors the state of the bus for a predetermined period in a case where the transmission request is accepted, and determines from which battery pack unit the bus accepts the request according to a change in state of the bus for the predetermined period.

In the bus arbitration of the embodiment, a sampling timing of the received data is generated (reception clock reproduction) from the received request signal. Since a frequency and a phase generated by an oscillator of each battery pack unit 20 are different, the sampling timing of the received data is generated from edge information of the received data (request signal). After falling of the request signal is detected, an internal counter is activated. After the falling of the request signal is detected, an internal counter value is held, the counter is cleared, and counting up is performed. In a case where the second connection port 21B performs reception, the request signal of the first connection port 21A corresponds to two cycles, and thus, the received data is latched with a value of ¼ of the held counter value, and the counter is cleared with a value of ½ of the held count value. In a case where the first connection port performs reception, the request signal of the second connection port corresponds to one cycle, and thus, the received data is latched with a value of ½ of the held counter value, and the counter is cleared with the held count value. As described above, the request signal of the first connection port 21A is a signal having a length different from that of the request signal of the second connection port 21B. The request signal of the first connection port 21A is a signal corresponding to two cycles, which is longer than one cycle of the request signal of the second connection port 21B. A period of the request signal of the second connection port 21B is half of a period of two cycles of the request signal of the first connection port 21A. The length of the cycle is not limited to two cycles and one cycle. Further, details of the bus arbitration timing charts of (A) to (C) are described below as a supplement after the main content of the embodiment is described.

### [Flow of Communication Processing]

A flow of communication processing when the transmission requests (hereinafter, output commands) are simultaneously transmitted in the battery monitoring system 1 will be described. The communication interface circuit 30 receives, as the request, the output command for the monitoring data of each cell according to an instruction from the battery management circuit 40. In the battery monitoring system 1, the output commands are simultaneously transmitted from the third connection port 31A and the fourth connection port 31B of the communication interface circuit 30 to both the first connection port 11A of the group and the second connection port 11B of the group in the battery pack unit group. In the battery monitoring system 1, communication control is performed such that the output commands are transmitted to all of the plurality of battery pack units 20, and communication data output from the plurality of battery pack units 20 is output from both connection ports.

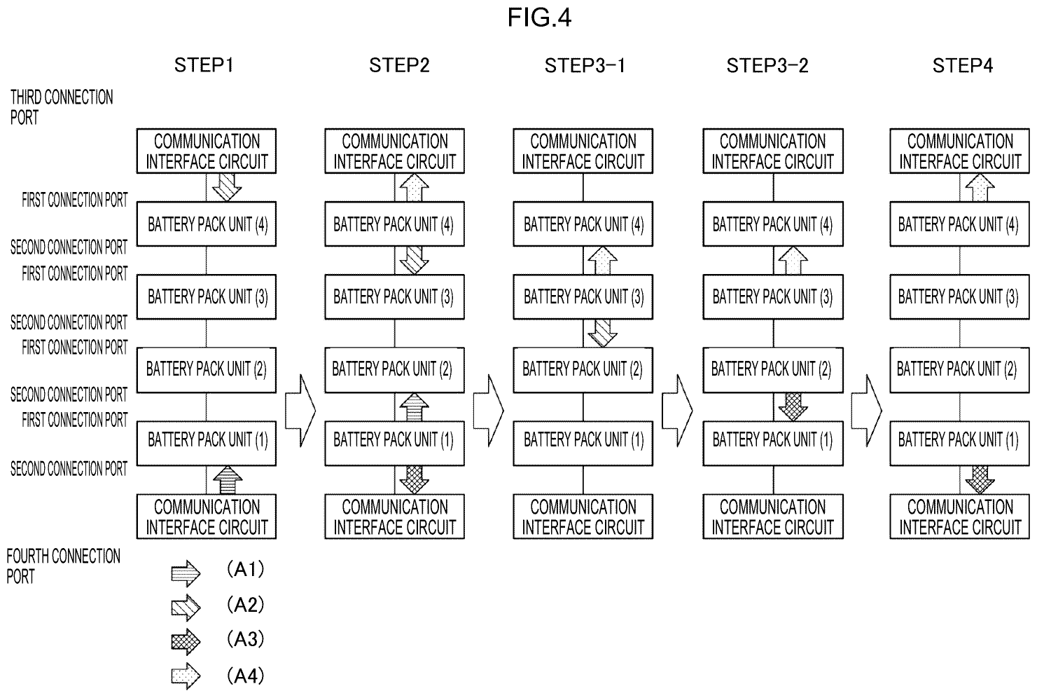

FIG. 4 is a diagram showing an example of time transition of communication in a case where the communication interface circuit 30 simultaneously transmits the requests and the output commands are received from both directions by certain battery pack units 20. In FIG. 4, a flow from STEP 1 to STEP 4 is shown as time transition of communication between the communication interface circuit 30 and the battery pack unit group 10 in which four battery pack units 20 are connected. For convenience of description, the four battery pack units 20 are denoted by Reference Numerals (1) to (4) in the form of a battery pack unit (N).

In FIG. 4, arrows (A1) to (A4) indicating the flow of communication are shown. (A1) and (A2) are the output commands, and (A3) and (A4) are the monitoring data (hereinafter, communication data). (A1) is the output command (first output command) for the monitoring data from the fourth connection port 31B of the communication interface circuit 30. (A2) is the output command (second output command) for the monitoring data from the third connection port 31A of the communication interface circuit. (A3) is the communication data as the monitoring data that is output in response to the output command for the monitoring data from the fourth connection port 31B of the communication interface circuit 30. (A4) is the communication data as the monitoring data that is output in response to the output command for the monitoring data from the third connection port 31A of the communication interface circuit 30. For convenience of description, the first connection port 11A of the group and the second connection port 11B of the group are omitted.

In STEP 1, the third connection port 31A and the fourth connection port 31B of the communication interface circuit 30 simultaneously transmit the output commands. The battery pack unit (1) receives the output command at the second connection port 21B from the fourth connection port 31B, and the battery pack unit (4) receives the output command at the first connection port 21A from the third connection port 31A. In STEP 2, the battery pack unit (1) outputs the output command of (A1) from the first connection port 21A, and outputs the communication data from the second connection port 21B. That is, the output command of (A1) is output from the first connection port 21A of the battery pack unit (1) to the adjacent battery pack unit (2). The battery pack unit (4) outputs the output command of (A2) from the second connection port 21B, and outputs the communication data from the first connection port 21A. That is, the output command of (A2) is output from the second connection port 21B of the battery pack unit (4) to the adjacent battery pack unit (3).

In STEPS 3-1 and 3-2, arbitration processing is performed in the battery pack unit when a plurality of output commands are transmitted to a certain battery pack unit. The arbitration processing is different from the bus arbitration processing described above. In STEP 3-1, the output command of (A2) is received from the battery pack unit (3) before the battery pack unit (2) outputs the output command of (A1). In this case, in the battery pack unit (2), as shown in STEP 3-2, the communication data of (A3) is first output from the second connection port 21B according to the output command of (A1) from the second connection port 21B, and the output command of (A2) received from the first connection port 21A after receiving (A1) is ignored without being processed.

In addition, the output command of (A1) from the second connection port 21B is not output from the first connection port 21A. In STEP 4, the pieces of communication data of the battery pack unit (2) and the battery pack unit (3) are output to the communication interface circuit 30. In the embodiment, the requests simultaneously transmitted in this manner are processed through both paths, and arbitration in the battery pack unit is controlled such that the requests are propagated until a collision occurs. Further, the pieces of communication data are output from both the first connection port 11A of the group and the second connection port 11B of the group to the communication interface circuit 30.

As described above, in communication control, output of each of the plurality of battery pack units 20 is controlled. In a case where the output command is received from the first connection port 21A first, the communication data is output from the first connection port 21A, and the output command is further transmitted from the second connection port 21B to the first connection port 21A of the adjacent battery pack unit 20. Further, the communication data of the adjacent battery pack unit 20 is output from the first connection port 21A of the adjacent battery pack unit 20, and is received by the second connection port 21B. As a result, the communication data passing through the daisy chain connection is output from the first connection port 11A of the group.

In a case where the output command is received from the second connection port 21B first, the communication data is output from the second connection port 21B, and the output command is further transmitted from the first connection port 21A to the second connection port 21B of the adjacent battery pack unit 20. Further, the communication data of the adjacent battery pack unit 20 is output from the second connection port 21B of the adjacent battery pack unit 20, and is received by the first connection port 21A. As a result, the communication data passing through the daisy chain connection is output from the second connection port 11B of the group.

In a case where the output command is received from the second connection port 21B after receiving the output command from the first connection port 21A, the output command from the second connection port 21B is ignored, and the output command from the first connection port 21A is not output from the second connection port 21B. In a case where the output command is received from the first connection port 21A after receiving the output command from the second connection port 21B, the output command from the first connection port 21A is ignored, and the output command from the second connection port 21B is not output from the first connection port 21A.

### [Flow of Abnormality Detection]

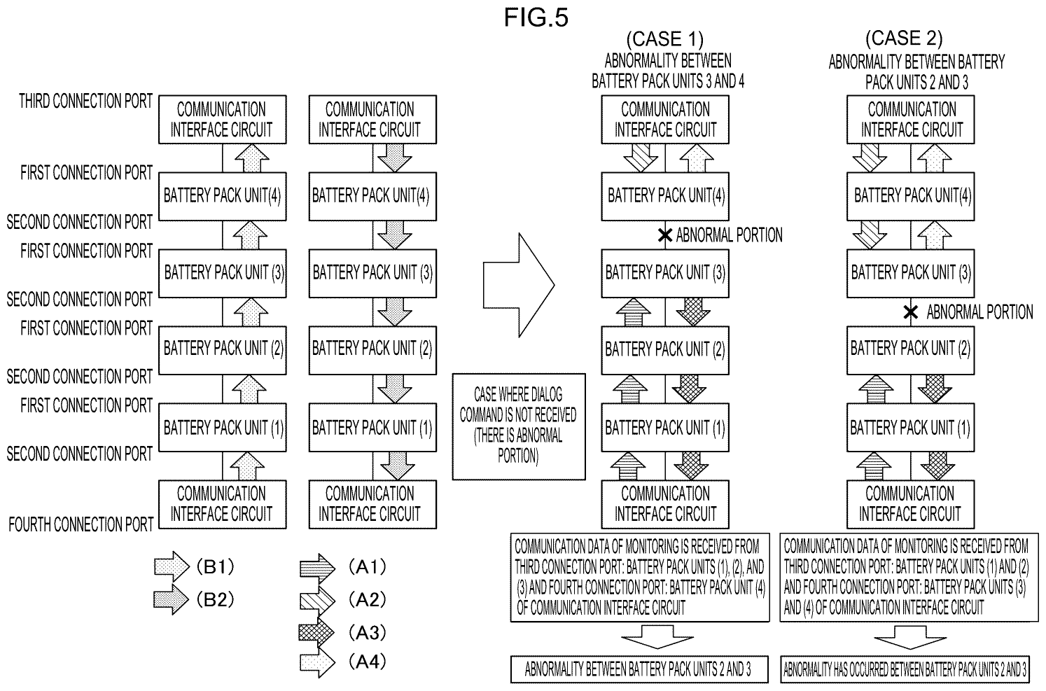

In abnormality detection in the battery monitoring system 1, a communication path dialog command is periodically transmitted to detect an abnormality and detect an abnormal portion. FIG. 5 is a diagram showing an example of abnormality detection and abnormal portion detection using the communication path dialog command.

In FIG. 5, arrows (B1) and (B2) indicating a communication flow are shown. (B1) and (B2) are the communication path dialog commands. (B1) is the communication path dialog command (first communication path dialog command) from the fourth connection port 31B of the communication interface circuit 30. (B2) is the communication path dialog command (second communication path dialog command) from the third connection port 31A of the communication interface circuit 30.

The communication path dialog command of (B1) is transmitted from the fourth connection port 31B of the communication interface circuit 30 and passes through each path of each battery pack unit 20 of the battery pack unit group 10, and the transmitted communication path dialog command of (B1) is received from the third connection port 31A. Further, the communication path dialog command of (B2) is transmitted from the third connection port 31A of the communication interface circuit 30 and passes through each path of each battery pack unit 20 of the battery pack unit group 10, and the transmitted communication path dialog command of (B2) is received from the fourth connection port 31B. At this time, in a case where the communication interface circuit 30 fails to receive the communication path dialog command of at least one of (B1) or (B2), the battery management circuit 40 detects that there is an abnormality in the communication path.

In a case where it is detected that there is an abnormality in the communication path, the abnormal portion is detected by receiving a collision position of the output commands. As described in the bus arbitration, the output commands for the monitoring data are simultaneously transmitted from the third connection port 31A and the fourth connection port 31B of the communication interface circuit 30. Each of the battery pack units 20 that received the output commands outputs the communication data obtained by monitoring from which connection port of the communication interface circuit 30 data is received. That is, the communication data is information regarding which of the requests of the output commands (A1) and (A2) has been processed. Then, a portion where reception is performed at different connection ports between the adjacent battery pack units 20 is detected as the abnormal portion. In Case 1 of FIG. 5, the battery pack units (1), (2), and (3) process the output command of (A1) from the fourth connection port 31B, and the battery pack unit (4) processes the output command of (A2) from the third connection port 31A. In this case, it is detected that the path between the battery pack unit (3) and the battery pack unit (4) is the portion where the abnormality has occurred. In Case 2, the battery pack units (1) and (2) process the output command of (A1) from the fourth connection port 31B, and the battery pack units (3) and (4) process the output command of (A2) from the third connection port 31A. In this case, it is detected that the path between the battery pack unit (2) and the battery pack unit (3) is the portion where the abnormality has occurred.

With the bus arbitration processing as described above, the battery monitoring system 1 can perform communication control of the bus arbitration to enable communication using paths of both directions in the daisy chain connection at the same time.

### [Supplement to Timing Charts of Bus Arbitration]

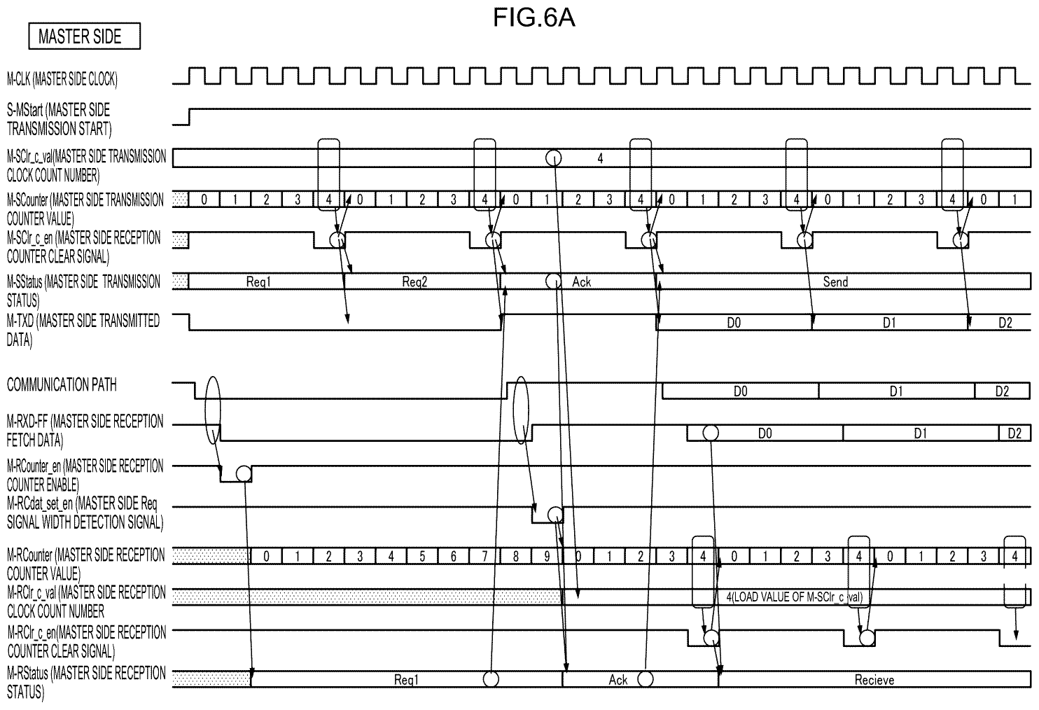

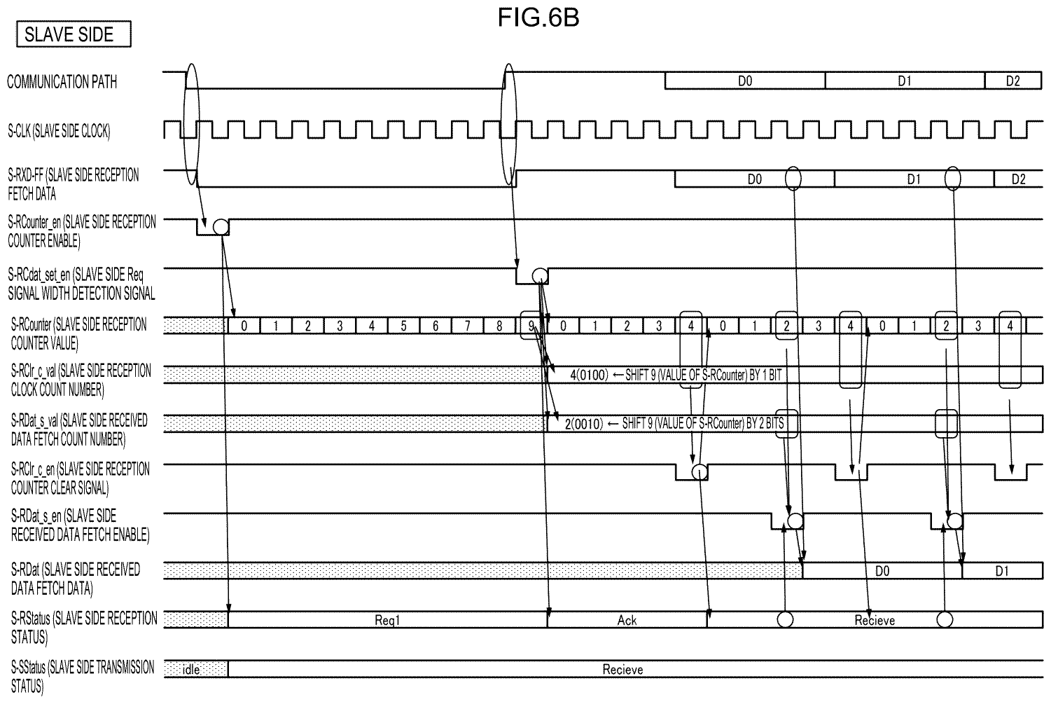

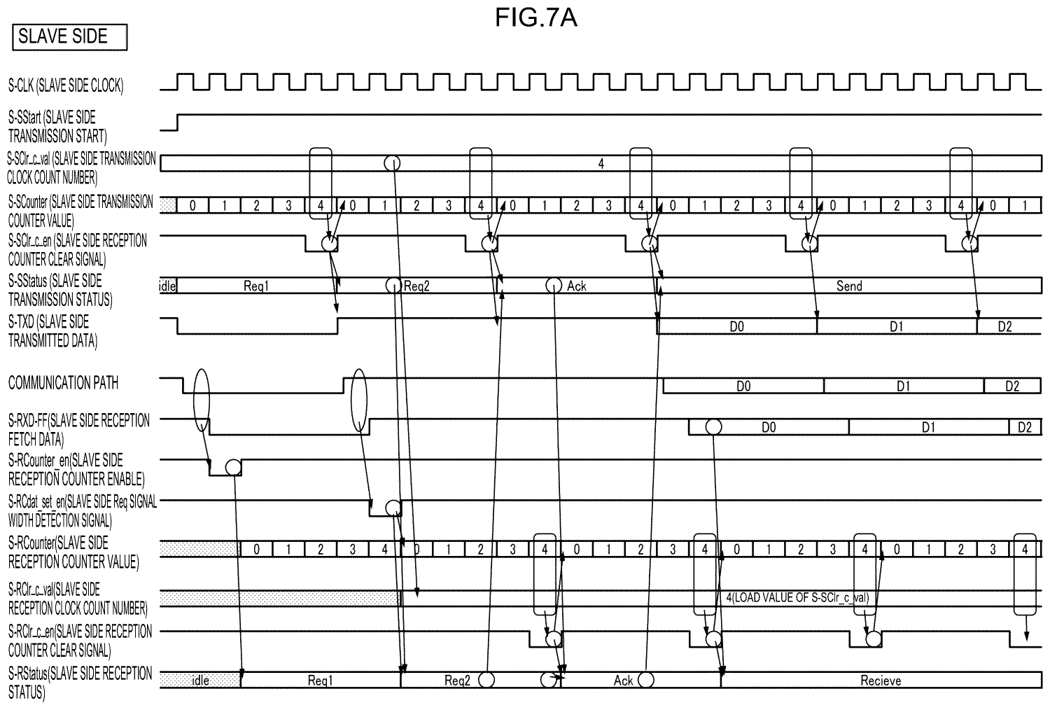

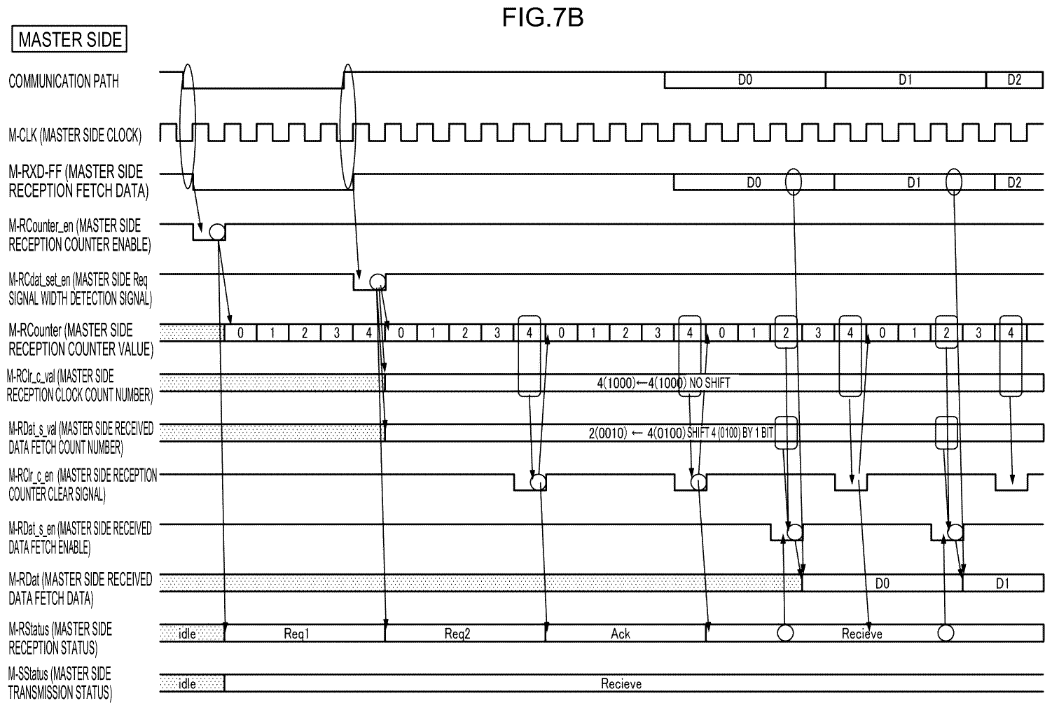

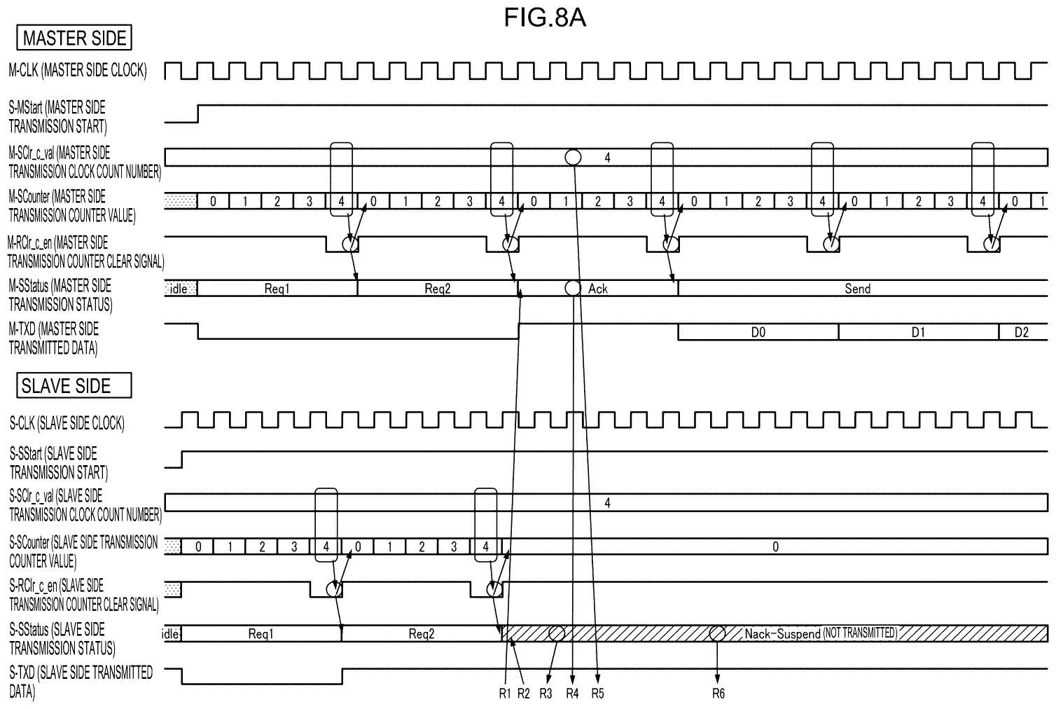

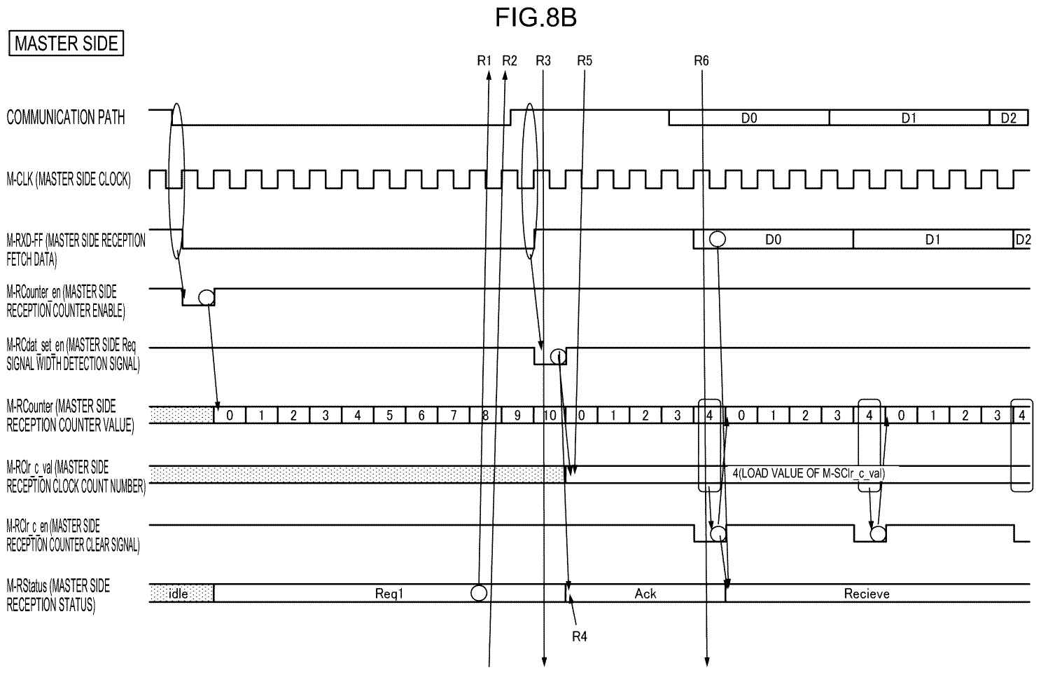

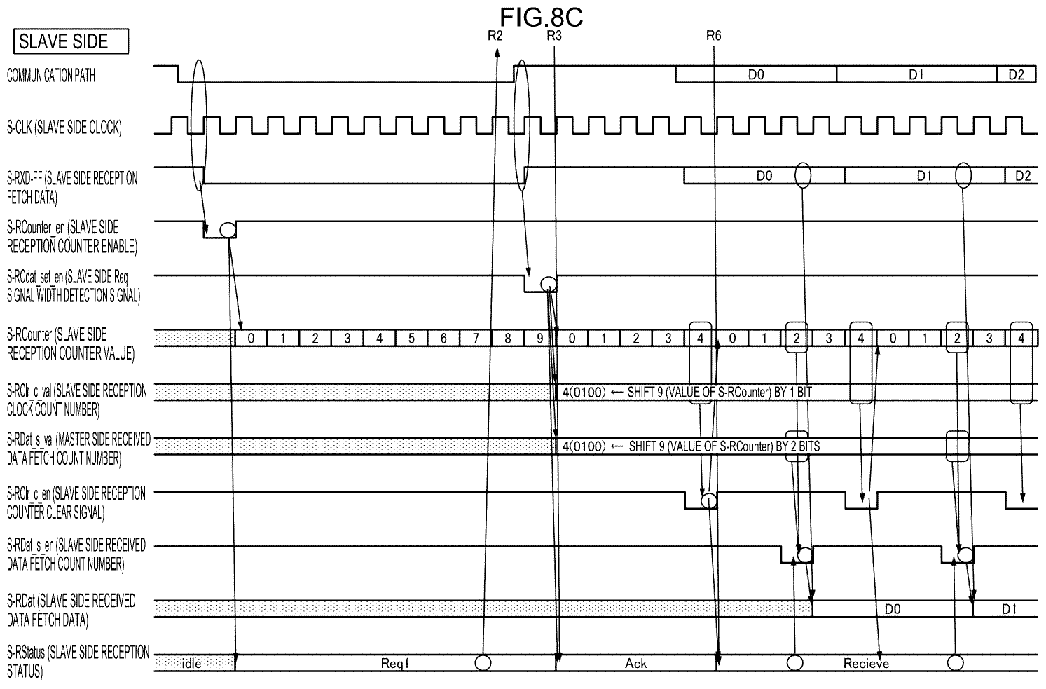

Details of the timing charts of the bus arbitration will be supplemented. The timing chart of each of (A) to (C) shown in FIG. 3 is shown. FIGS. 6A to 6B are timing charts of (A) shown in FIG. 3 in a case where the communication circuit 24 transmits the transmission request only to the first connection port 21A. FIGS. 7A to 7B are timing charts of (B) shown in FIG. 3 in a case where the communication circuit 24 transmits the transmission request only to the second connection port 21B. FIGS. 8A to 8C are timing charts of (C) shown in FIG. 3 in a case where different communication circuits 24 simultaneously transmit the transmission requests to the first connection port 21A and the second connection port 21B of one bus. The master side is the first connection port 21A, and the slave side is the second connection port 21B.

In FIGS. 6A and 6B showing the case of (A), FIG. 6A shows the master side and FIG. 6B shows the slave side. The bus ownership is with the master, and data is transferred from the master to the slave. In this case, the reception status on the master side becomes Reg1 to process the request received by the first connection port 21A, it is recognized that no bus conflict occurs, and M-Status transitions to Ack.

Each of the master and the slave performs communication control at the connection port 21A in order to process the request. In the communication control on the master side in the case of (A), M-CLK (master side clock), S-MStart (master side transmission start), M-SCIr_c_val (master side transmission clock count number), M-SCounter (master side transmission counter value), M-SClr_c_en (master side reception counter clear signal), M-SStatus (master side transmission status), and M-TXD (master side transmitted data) are controlled. In addition, M-RXD-FF (master side reception fetch data), M-RCounter_en (master side reception counter enable), M-RCdat_set_en (master side Req signal width detection signal), M-RCounter (master side reception counter value), M-RClr_c_val (master side reception clock count number), M-RClr_c_en (master side reception counter clear signal), and M-RStatus (master side reception status) are controlled.

In the communication control on the slave side in the case of (A), S-CLK (slave side clock), S-RXD-FF (slave side reception fetch data), S-RCounter_en (slave side reception counter enable), S-RCdat_set_en (slave side Req signal width detection signal), S-RCounter (slave side reception counter value), S-RClr_c_val (slave side reception clock count number), S-RDat_s_val (slave side received data fetch count number), S-RClr_c_en (slave side reception counter clear signal), S-RDat_s_en (slave side received data fetch enable), S-RDat (slave side received data fetch data), S-RStatus (slave side reception status), and S-SStatus (slave side transmission status) are controlled. Hereinafter, in a case where the transmission request is transmitted to the second connection port 21B in FIGS. 7A and 7B in the case of (B), the master and the slave are switched.

In FIGS. 7A and 7B showing the case of (B), FIG. 7A shows the slave side, and FIG. 7B shows the master side. The bus ownership is with the slave, and data is transferred from the slave to the master. In this case, the reception status on the slave side becomes Req2 to process the request received by the second connection port 21B, it is recognized that no bus conflict occurs, and S-Status transitions to Ack.

In FIGS. 8A to 8C showing the case of (C), FIG. 8A shows the master side and the slave side, FIG. 8B shows the master side, and FIG. 8C shows the slave side. The bus ownership is with the master, and data is transferred from the master to the slave. Arrows R1 to R6 indicate crossing of the timing chart. As indicated by R1, the reception status on the slave side is not Req2, and thus, it is recognized that a bus conflict has occurred. In a case where a bus conflict has occurred, the master side and the slave side already have the same information by simultaneous communication, but the master side cannot recognize Req on the slave side, and thus continues to perform transmission. Since the reception status on the slave side is not Req2, it is recognized that a bus conflict has occurred, and transmission is stopped. As indicated by R6, although the slave side receives data from the master side, the slave side eventually discards the received data because the slave side already has the same information by simultaneous communication and is about to transmit the data to the master side. A timing when the bus is released is monitored. In a case where Req on the slave side is output earlier than a Req signal transmitted from the master side, there is a possibility that the master side receives the Req signal in the form of the communication path one cycle longer.

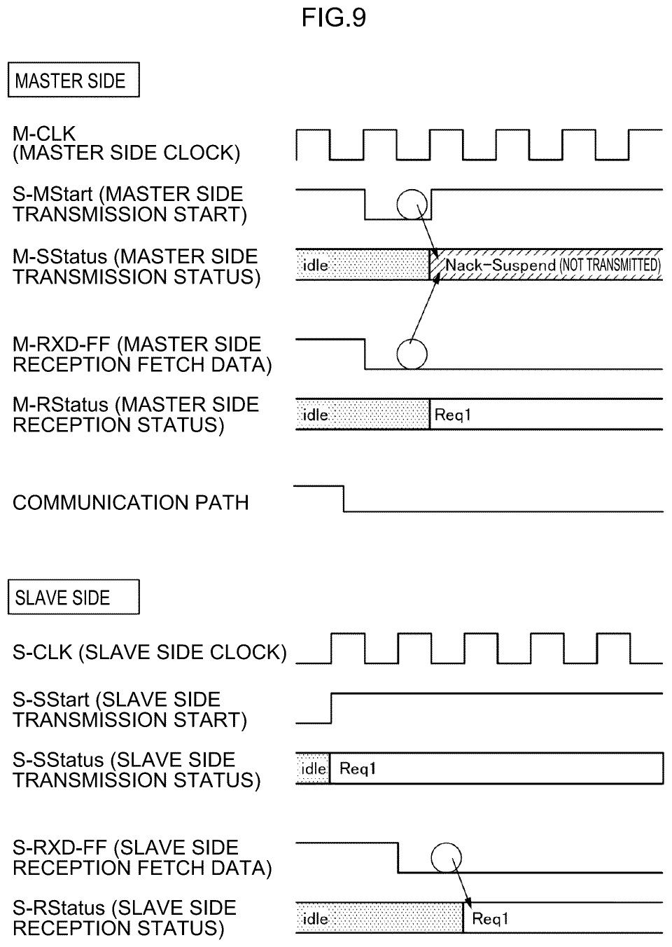

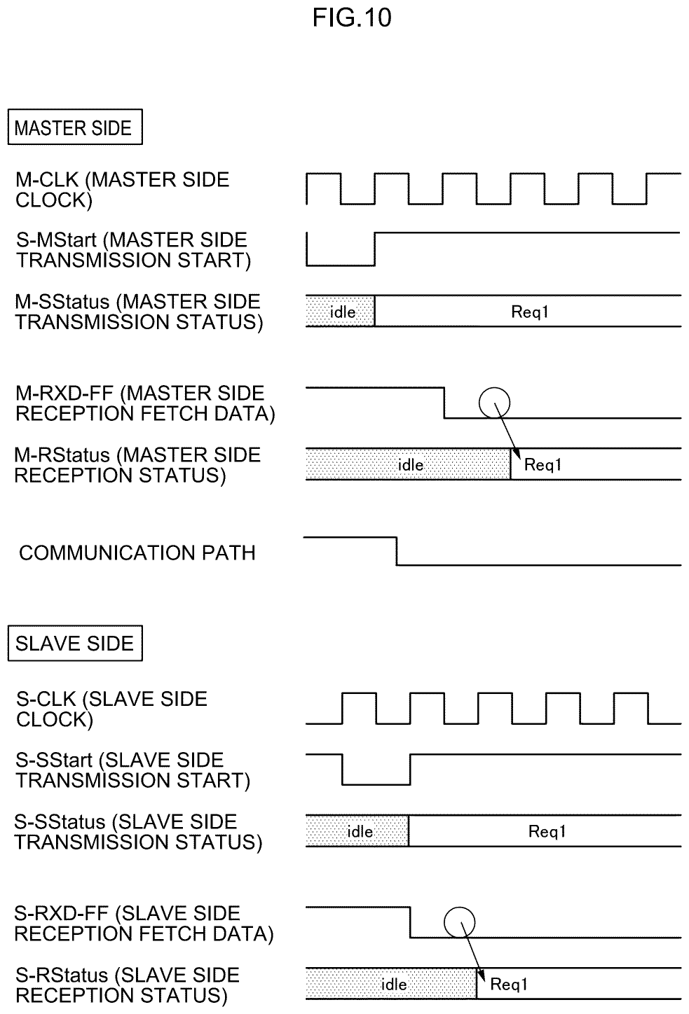

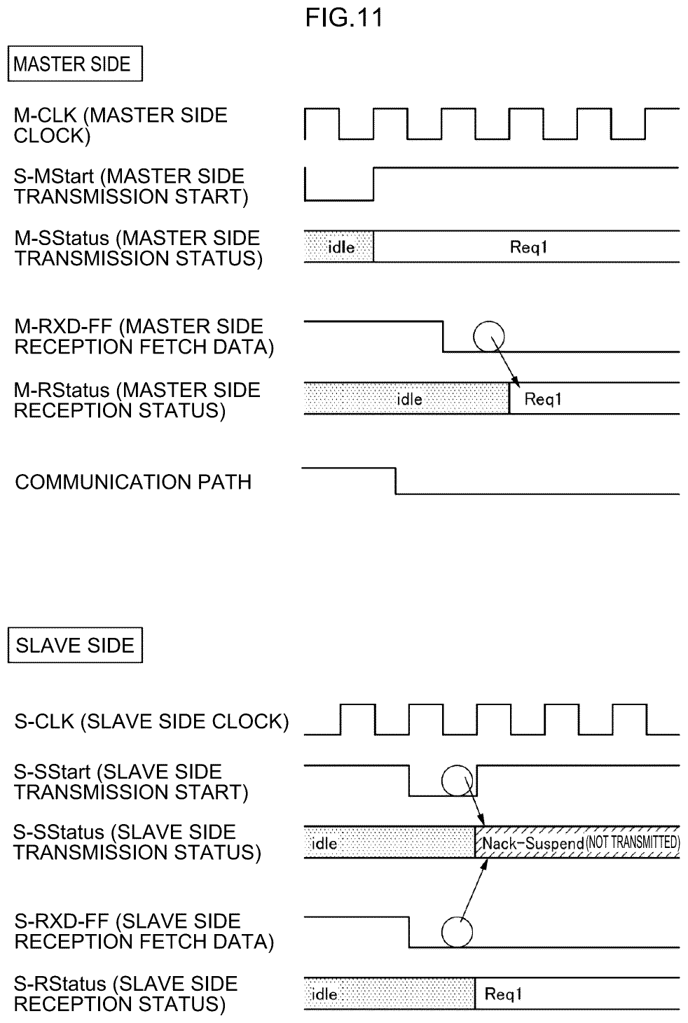

FIG. 9 shows a case where the slave first makes a Req request, and the bus ownership is with the slave, and data is transferred from the slave to a master. FIG. 10 shows a case where both the master and the slave simultaneously make the Req requests, the bus ownership is with the master, and data is transferred from the master to the slave (similar to FIGS. 8A to 8C). FIG. 11 shows a case where the master first makes the Req request, the bus ownership is with the master, and data is transferred from the master to the slave.

Note that the disclosure is not limited to the above-described embodiment, and various modifications and applications can be made without departing from the gist of the technology of the disclosure.

For example, the bus arbitration processing method described in the embodiment can be applied not only to the battery monitoring system but also to a bus control method having a daisy chain configuration.

The disclosure of Japanese Patent Application No. 2022-033892 filed on Mar. 4, 2022 is incorporated herein by reference in its entirety. All documents, patent applications, and technical standards mentioned herein are incorporated herein by reference to the same extent as if each individual document, patent application, and technical standard were specifically and individually stated.

1. A battery monitoring system, comprising:
a battery pack unit including a cell monitoring circuit that monitors a plurality of cells, a communication circuit for transmitting obtained monitoring data to an exterior, and first and second connection ports for transmitting communication data including the monitoring data;
a battery pack unit group in which a plurality of the battery pack units are connected in series;
a battery management circuit configured to control the battery pack unit in response to the monitoring data of each cell in the battery pack unit; and
a communication interface circuit arranged so as to transmit the monitoring data between the battery pack unit group and the battery management circuit, wherein:
connections between the battery pack units of the battery pack unit group are configured such that:
a first connection port of the battery pack unit is connected to a second connection port of an adjacent battery pack unit,
a second connection port of the battery pack unit is connected to a first connection port of another adjacent battery pack unit to form the battery pack unit group in which the battery pack units are connected in series by a daisy-chain connection,
the battery pack unit group includes a first connection port of the group and a second connection port of the group,
the first connection port of the group is connected to a fourth connection port of the communication interface circuit,
the second connection port of the group is connected to a third connection port of the communication interface circuit, and
when the communication interface circuit receives an output command for the monitoring data of each cell according to an instruction from the battery management circuit, the output commands are simultaneously transmitted from the third connection port and the fourth connection port of the communication interface circuit to both of the first connection port of the group and the second connection port of the group in the battery pack unit group, communication control is performed such that the output commands are transmitted to all of the plurality of battery pack units, and the communication data output from each of the plurality of battery pack units is output from both of the connection ports.

2. The battery monitoring system according to claim 1, wherein, in the communication control:
in a case in which the output command is first received from the first connection port, each of the plurality of battery pack units outputs the communication data from the first connection port and further transmits the output command from the second connection port to the first connection port of an adjacent battery pack unit, the communication data of the adjacent battery pack unit is output from the first connection port of the adjacent battery pack unit and is received by the second connection port, and the communication data passing through the daisy-chain connection is output from the first connection port of the group,
in a case in which the output command is first received from the second connection port, each of the plurality of battery pack units outputs the communication data from the second connection port and further transmits the output command from the first connection port to the second connection port of the adjacent battery pack unit, the communication data of the adjacent battery pack unit is output from the second connection port of the adjacent battery pack unit and is received by the first connection port, and the communication data passing through the daisy-chain connection is output from the second connection port of the group,
in a case in which the output command is received from the second connection port after the output command is received from the first connection port, each of the plurality of battery pack units ignores the output command from the second connection port and does not output the output command from the first connection port from the second connection port, and
in a case in which the output command is received from the first connection port after the output command is received from the second connection port, each of the plurality of battery pack units ignores the output command from the first connection port and does not output the output command from the second connection port from the first connection port.

3. The battery monitoring system according to claim 1, wherein:
processing for transmitting a communication path dialog command from the third connection port of the communication interface circuit, passing the communication path dialog command through the daisy-chain connection of the battery pack unit group, and receiving the transmitted communication path dialog command from the fourth connection port, and processing for transmitting a communication path dialog command from the fourth connection port of the communication interface circuit, passing the communication path dialog command through the daisy chain connection of the battery pack unit group, and receiving the transmitted communication path dialog command from the third connection port, are performed, and
an abnormality in a communication path is detected in a case in which at least one of the communication path dialog commands is not received.

4. The battery monitoring system according to claim 3, wherein the output commands of the monitoring data are simultaneously transmitted from the third connection port and the fourth connection port of the communication interface circuit in a case in which an abnormality in the communication path is detected, and the communication data, obtained by monitoring from which connection port of the communication interface circuit each of the received battery pack units has received data, is output to detect, as an abnormal portion, a portion at which reception is performed at different connection ports between adjacent battery pack units.

5. A battery monitoring method in a battery monitoring system, the system comprising:
a battery pack unit including a cell monitoring circuit that monitors a plurality of cells, a communication circuit for transmitting obtained monitoring data to an exterior, and first and second connection ports for transmitting communication data including the monitoring data;
a battery pack unit group in which a plurality of the battery pack units are connected in series;
a battery management circuit configured to control the battery pack unit in response to the monitoring data of each cell in the battery pack unit; and
a communication interface circuit arranged so as to transmit the monitoring data between the battery pack unit group and the battery management circuit,
wherein connections between the battery pack units of the battery pack unit group are configured such that:
a first connection port of the battery pack unit is connected to a second connection port of an adjacent battery pack unit,
a second connection port of the battery pack unit is connected to a first connection port of another adjacent battery pack unit to form the battery pack unit group in which the battery pack units are connected in series by a daisy-chain connection,
the battery pack unit group includes a first connection port of the group and a second connection port of the group,
the first connection port of the group is connected to a fourth connection port of the communication interface circuit, and
the second connection port of the group is connected to a third connection port of the communication interface circuit,
the method comprising:
receiving an output command in the communication interface circuit for the monitoring data of each cell according to an instruction from the battery management circuit;
simultaneously transmitting the output commands from the third connection port and the fourth connection port of the communication interface circuit to both of the first connection port of the group and the second connection port of the group in the battery pack unit group;
performing communication control such that the output commands are transmitted to all of the plurality of battery pack units; and
outputting the communication data from each of the plurality of battery pack units from both of the connection ports.

6. The battery monitoring method according to claim 5, wherein, in the communication control:
in a case in which the output command is first received from the first connection port, each of the plurality of battery pack units outputs the communication data from the first connection port and further transmits the output command from the second connection port to the first connection port of an adjacent battery pack unit, the communication data of the adjacent battery pack unit is output from the first connection port of the adjacent battery pack unit and is received by the second connection port, and the communication data passing through the daisy-chain connection is output from the first connection port of the group,
in a case in which the output command is first received from the second connection port, each of the plurality of battery pack units outputs the communication data from the second connection port and further transmits the output command from the first connection port to the second connection port of the adjacent battery pack unit, the communication data of the adjacent battery pack unit is output from the second connection port of the adjacent battery pack unit and is received by the first connection port, and the communication data passing through the daisy-chain connection is output from the second connection port of the group,
in a case in which the output command is received from the second connection port after the output command is received from the first connection port, each of the plurality of battery pack units ignores the output command from the second connection port and does not output the output command from the first connection port from the second connection port, and
in a case in which the output command is received from the first connection port after the output command is received from the second connection port, each of the plurality of battery pack units ignores the output command from the first connection port and does not output the output command from the second connection port from the first connection port.

7. The battery monitoring method according to claim 5, wherein:
processing for transmitting a communication path dialog command from the third connection port of the communication interface circuit, passing the communication path dialog command through the daisy-chain connection of the battery pack unit group, and receiving the transmitted communication path dialog command from the fourth connection port, and processing for transmitting a communication path dialog command from the fourth connection port of the communication interface circuit, passing the communication path dialog command through the daisy chain connection of the battery pack unit group, and receiving the transmitted communication path dialog command from the third connection port, are performed, and
an abnormality in a communication path is detected in a case in which at least one of the communication path dialog commands is not received.

8. The battery monitoring method according to claim 7, wherein the output commands of the monitoring data are simultaneously transmitted from the third connection port and the fourth connection port of the communication interface circuit in a case in which an abnormality in the communication path is detected, and the communication data, obtained by monitoring from which connection port of the communication interface circuit each of the received battery pack units has received data, is output to detect, as an abnormal portion, a portion at which reception is performed at different connection ports between adjacent battery pack units.
